(19) United States
(12) Patent Application Publication
(10) Pub. No.: US 2010/0018291 A1
(43) Pub. Date: Jan. 28, 2010

(54) REVERSE PARTICULATE MATTER SENSOR

(76) Inventor: Matthew B. Below, Findlay, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/508,272

(22) Filed: Jul. 23, 2009

Related U.S. Application Data
(63) Continuation-in-part of application No. 12/467,673, filed on May 18, 2009.
(60) Provisional application No. 61/083,328, filed on Jul. 24, 2008.
(60) Provisional application No. 61/083,333, filed on Jul. 24, 2008.

(51) Int. Cl. G01N 37/00

(52) U.S. Cl. 73/28.01

(57) ABSTRACT

Exemplary embodiments of the present invention relate to methods and devices for monitoring the flow of particulate matter within an exhaust gas stream. In one exemplary embodiment, a particulate matter sensor for an exhaust system of an engine is provided. The sensor includes a casing having an attachment feature for mounting the particulate matter sensor to the exhaust system. The sensor also includes an insulator disposed within the casing. The insulator has a first end located proximate to an electrical connector of the particulate matter sensor and a second end located opposite thereof The sensor further includes a sensing rod having a first end and a second end. The first end of the sensing rod is supported by the insulator and spaced from the second end of the insulator to form a gap therebetween.

### CROSS REFERENCE TO RELATED APPLICATIONS

This application claims the benefit of U.S. Provisional Patent Application Ser. No. 61/083,328 filed Jul. 24, 2008 the contents of which are incorporated herein by reference thereto.

This application is also a continuation-in-part U.S. patent application Ser. No. 12/467,673, filed May 18, 2009 the contents of which are incorporated herein by reference thereto.

This application is also related to U.S. Provisional Patent Application Ser. No. 61/083,333 filed Jul. 24, 2008 and U.S. patent application Ser. No. 12/508,096 filed Jul. 23, 2009, the contents each of which are incorporated herein by reference thereto.

### FIELD OF THE INVENTION

Exemplary embodiments of the present invention relate to methods and devices for monitoring particulate matter flow within an exhaust gas stream.

### BACKGROUND

Particulate matter sensors are used to monitor particulate matter flowing into a particulate matter filter. These sensors are particularly useful for determining when a regeneration process of the particulate matter filter is necessary. This monitoring is often achieved through a particulate matter sensor placed within the exhaust gas stream, wherein a signal is generated based upon an amount of particulate matter flowing past the sensor. However, sensors can fail to provide accurate readings due to a complete or partial grounding of the signal. This electric grounding, or short, can be caused by a deposit of particulate matter formed between a sensing rod and metal casing of the particulate matter sensor, typically along an insulator of the sensor. This accumulation of deposits may require regeneration of the particulate matter sensor via heating of the same in order to remove the particulate matter build up. Repetitive regeneration not only requires energy but can also have a negative effect on the particulate matter sensor, filter or otherwise.

Accordingly, there is a need for improved methods and devices for monitoring the flow of particulate matter within an exhaust gas stream and for improving accuracy of the sensor and reducing regeneration frequency of the same.

### SUMMARY OF THE INVENTION

Exemplary embodiments of the present invention relate to methods and devices for monitoring the flow of particulate matter within an exhaust gas stream. In one exemplary embodiment, a particulate matter sensor for an exhaust system of an engine is provided. The sensor includes a casing having an attachment feature for mounting the particulate matter sensor to the exhaust system. The sensor also includes an insulator disposed within the casing. The insulator has a first end located proximate to an electrical connector of the particulate matter sensor and a second end located opposite thereof The sensor further includes a sensing rod having a first end and a second end. The first end of the sensing rod is supported by the insulator and spaced from the second end of the insulator to form a gap therebetween.

In another exemplary embodiment, a method of monitoring particulate matter flowing within an exhaust gas stream is provided. The method includes supporting a sensing rod with an insulator disposed between the sensing rod and a casing. The insulator is shaped to form a gap between the insulator and the sensing rod. The method further includes positioning the sensing rod within the exhaust gas stream and maintaining the position of the sensing rod through the casing. The method also includes generating electrical signals with the sensing rod based upon particulate matter flowing within the exhaust gas stream.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 illustrates an elevational view of an exemplary embodiment of a sensor according to the teachings of the present invention;

FIG. 2 illustrates an end view of the sensor shown in FIG. 1;

FIG. 3 illustrates a cross-sectional view taken along lines 3-3 of the sensor shown in FIG. 1;

FIG. 4 illustrates an enlarged view of the sensor shown in FIG. 3; and

FIG. 5 illustrates a schematic view of an exhaust control system including one or more sensors according to an exemplary embodiment of the present invention.

### DETAILED DESCRIPTION OF EXEMPLARY EMBODIMENTS

Reference is made to the following U.S. Pat. Nos. 6,971,258; 7,275,415; and 4,111,778 the contents each of which are incorporated herein by reference thereto.

Exemplary embodiments of the present invention provide methods, systems and devices for detecting and monitoring particulate matter flowing in an exhaust gas stream. In one particular exemplary embodiment, a particulate matter sensor is provided wherein a sensing rod is electrically insulated from a metal casing though a non-conductive insulator having a configuration that provides an increased distance between a surface of the sensing rod and the metal casing of the particulate matter sensor. This increased distance prevents or inhibits the formation of an electrical ground, or otherwise, between the sensing rod and metal casing.

In another particular exemplary embodiment, a particulate matter sensor is provided having a gap formed between the sensing rod and an inner surface of the insulator of the particulate matter sensor. As with the above configuration, this embodiment prevents or inhibits the formation of an electric ground, or otherwise, through an increased distance between the sensing rod and metal casing. This configuration also causes a portion of the insulator disposed between the metal sensing rod and the metal connector to run hotter or adsorb more heat thereby burning off carbon deposits on this portion of the insulator and thus increase the length of a ground path from the metal probe to the ground plane/shell. One way of causing this portion of the insulator to adsorb more heat is by circulation of heated exhaust gas about and within a cavity formed by the insulator which surrounds a portion of the sensing rod. Heat adsorption of this portion of the insulator is also achieved through a reduction in material thickness of the insulator. The circulation ability and reduction in material thickness allows the temperature of the insulator to more rapidly increase, which reduces the heating temperature, time, or both, required for heating of this portion of the particulate matter sensor in order to burn off accumulated carbon or other deposits. It should become apparent that other novel features and advantageous of the present invention, as disclosed herein, exist.

In one embodiment, as exhaust gas flows past the sensing rod disposed in the exhaust gas or fluid stream signals are generated by the probe due to an electrical charge built up in the probe based upon the charge (e.g., electrical potential) of the particles flowing past the probe, wherein the signals are transmitted to a controller.

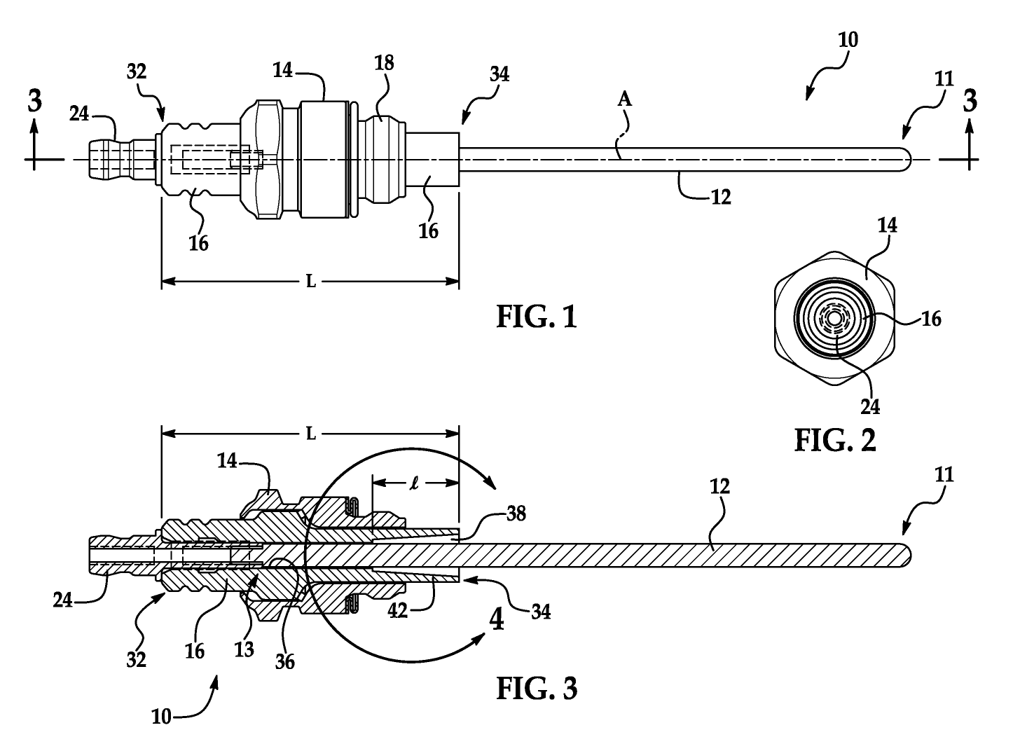

Referring to FIGS. 1-3, an exemplary embodiment of a particulate matter sensor 10 is shown. The particulate matter sensor 10 includes a sensing rod 12 having a first end 11 and a second end 13. The first end 11 of the sensing rod 12 is supported by a casing 14, through an insulator 16 disposed within the casing 16. The second end of the sensing rod 12 is configured for placement within an exhaust gas stream for detection of particulate matter flowing within the exhaust gas stream. In this configuration, the insulator 16 is configured to electrically insulate the sensing rod 12 from the casing 14 for preventing electrically grounding, or shorting, of the sensing rod.

Although one specific configuration of sensing rod 12 is illustrated sensing rod 12 may have any suitable configuration such as those illustrated in U.S. Patent Application Ser. No., 61/083,333 filed Jul. 24, 2008; Ser. No. 12/467,673, filed May 18, 2009; and Ser. No. 12/508,096 filed Jul. 23, 2009, the contents each of which are incorporated herein by reference thereto.

Referring also to FIG. 5, the casing includes an attachment feature, such as a threaded portion or any other suitable configuration 18, for attachment of the particulate matter sensor 10 to an exhaust component of an engine 20, such as an exhaust conduit 22, exhaust treatment device 30 or otherwise. Upon attachment, the sensing rod 12 extends within an exhaust gas flow traveling through the exhaust component thereby exposing the sensing rod and a portion of the insulator to the exhaust gas. The particulate matter sensor 10 further includes an electrical connector 24 for providing signal communication between the sensing rod 12 and a signal receiver, such as a controller 26. Accordingly, signals generated by the sensing rod are transmitted to the signal receiver through the electrical connector 24 connected to the second end 13 of the sensing rod.

Referring more specifically to FIG. 5, during operation of the engine 22, exhaust is generated and travels to an exhaust treatment device 28, such as a particulate matter filter 30, through exhaust conduit 22. The volume of particulate matter traveling to the particulate matter filter 30 is monitored through particulate matter sensor 10 and calculated through controller 26. The volume of particulate matter exiting the particulate matter filter 30 may also be monitored through a second particulate matter sensor 10′, which may include any of the particulate matter sensors described herein. The signals from the sensor or sensors may be used to vary the operation of the exhaust treatment device or other related device by for example monitoring the exhaust gases flowing past the sensors such that once a predetermined amount of particulate matter enters the particulate matter filter 30, as measured by the particulate matter sensor 10 or sensors, the particulate matter sensor(s) 10 and particulate matter filter 30 are regenerated to remove, e.g., annihilate, particulate matter trapped within the particulate matter filter 30 and/or located on the particulate matter sensor 10. It should be appreciated that the operation of the exhaust treatment system, including any regeneration process, may be achieved through the controller 26. Is should also be appreciated that a single sensor may be used either before or after the filter 30 or any other location in the system where particle monitoring is desired.

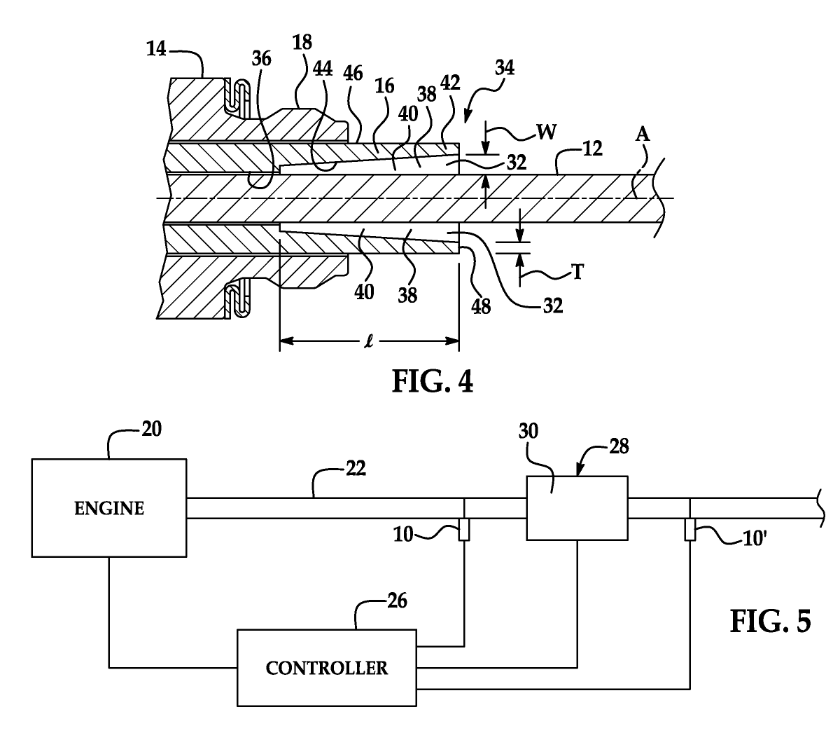

Illustrated in greater detail and referring to FIGS. 3 and 4, the insulator 16 includes a first end 32 located proximate to the electrical connector 24 and a second end 34 located opposite thereof Typically, the second end 34 of the insulator extends, along with the sensing rod, into an exhaust gas stream. The insulator 16 further includes an opening 36 extending through the insulator to receive a portion of the electrical connector 24 and sensing rod 12. The electrical connector may be joined or attached together through any suitable means (e.g., bonded or welded, mechanically attached or otherwise). Also, an intermediate connector (not shown) may also be used to form electrical connection between the electrical connector 24 and sensing rod 12. Accordingly, the opening 36 is configured to receive such attachment features.

The portion of opening 36 located at the first end 32 of the insulator 16 is configured to receive electrical connector 24 and the portion of the opening located at the second end 34 of the insulator 16 is configured to receive the sensing rod 12. In one particular exemplary embodiment, upon receiving the sensing rod 12 in the portion of the opening 36 located at the second end 34, a gap 38 is formed between the sensing rod 12 and insulator 16. The gap 38 includes a width ‘W’ and extends along a length ‘l’ of an insulator length “L” to form a cavity 40 between the insulator 16 and sensing rod 12. In this configuration, the cavity extends 360° about the sensing rod 12.

The width W of gap 38 may be constant or vary along the length l of the insulator. For example, the width W of the gap 38 may be constant towards the second end 34 of the insulator 16, may increase towards the second end 34 of the insulator 16, may decrease towards the second end 34 of the insulator, or may include a combination thereof Similarly, a cross-sectional area of the cavity may be constant along a length l of the insulator, may increase along a length l of the insulator, may decrease along a length l of the insulator or include a combination thereof. In one particular exemplary embodiment, with reference to FIG. 4, the width W of gap 38 increases in the direction of the second end 34 of the insulator 16. Accordingly, the cross-sectional area of the cavity 40, along the length l of the gap 38, increases in the direction of the second end 34 of the insulator 16 while the outer diameter remains the same such that a thickness of the distal end of the insulator 16 defining the opening or gap 38 at second end 34 is thinner thus allowing the same to heat up quicker and to a higher temperature than other thicker areas of the insulator, which as discussed above will allow this portion of the insulator to burn off carbon deposits on this portion of the insulator and thus prevent accumulation of deposits that may create a conductive path from the sensing rod to the metal casing. In addition, gap increases the length of a ground path from the metal probe to the ground plane/shell (e.g., the ground path includes the outer surface of the second end of the insulator, the second end of the insulator and the inner surface of the insulator defining the gap 38 and extending to the surface of the metal probe disposed in the gap or opening defined at the second end of the insulator. It should be appreciated that other configurations are contemplated to be within the scope of exemplary embodiments of the present invention.

In one exemplary embodiment and still referring to FIG. 4, the second end 34 of the insulator 16 includes a peripheral wall 42 extending about the sensing rod 12. The peripheral wall includes an inner surface 44 defining a portion of cavity 40 and outer surface 46. The inner surface 44 and/or outer surface 46 may be straight (e.g., extend parallel) or tapered (e.g., extend non-parallel) with respect to an axis ‘A’ of the sensing rod. Also, the inner surface 44 and/or outer surface 46 may include a combination of straight and tapered portions or include multiple straight (e.g., stepped configuration) or tapered portions.

In one configuration, as shown in FIG. 4, the inner surface 44 is tapered away from the axis A of the sensing rod 12 to form the increasing gap 38 in the direction of the second end 34 of the insulator. In this embodiment, the outer surface 46 extends generally parallel with respect to the axis A of the sensing rod 12. Accordingly, the thickness T of the peripheral wall decreases along the length L of the insulator 16, in the direction of the second end 34 of the insulator 16. In another configuration, the outer surface 46 of the peripheral wall 42 may be tapered towards the axis A of the sensing rod 12 and the inner surface 44 extends generally parallel with respect to the axis A of the sensing rod 12. In this configuration, the thickness T of the peripheral wall also decreases along the length L of the insulator 16, in the direction of the second end 34 of the insulator 16. It should be appreciated that the configuration of the inner surface 44 and outer surface 46 may be such that the thickness T of the peripheral wall 42 may be constant, increasing or decreasing in the direction of the first or second end 32, 34 of the insulator 16. Similarly, the inner surface 44 and outer surface 46 may be generally parallel to one another such that the entire peripheral wall tapers towards or away from the axis A of the sensing rod 12. It should be appreciated that other configurations are possible.

In one aspect, due to the forgoing gapped relationship between the sensing rod 12 and insulator 16, the surface distance (i.e., combination of inner surface 44, outer surface 46 and end surface 48) between contact of the insulator 16 with the sensing rod 12 and the casing 14 is greatly increased. Accordingly, the surface area in which particulate matter must cover, both internally and externally with respect to the insulator 16, to electrically ground the sensing rod 12 is also increased. This increased surface area provides improved resistance to electrical grounding or signal interference of the particulate matter sensor.

It is contemplated that the length l of the cavity 40 may be of any suitable length for causing increased surface area between the sensing rod 12 and the casing 14. This length l may be described in terms of ratio between the length l of the cavity 40 and the overall length L of the insulator 16. In one configuration, the length l of the cavity 40 formed by the gap 38 is at least about 1/10 the overall length L of the insulator 16. In another configuration, the length l of the cavity 40 formed by the gap 38 is at least about ⅛ the overall length L of the insulator 16. In another configuration the length l of the cavity 40 formed by the gap 38 is at least about ¼ the overall length L of the insulator 16. In still another configuration the length l of the cavity 40 formed by the gap 38 is at least about ⅓ the overall length L of the insulator 16. Other configurations are possible and exemplary embodiments of the present invention are not intended to be limited to the aforementioned values and lengths greater or less than the aforementioned ratios are contemplated to be within the scope of exemplary embodiments of the present invention.

In another embodiment, the peripheral wall 42, forming the gapped relationship with the sensing rod, causes the second end of the insulator to heat up quicker and to higher temperatures than other thicker areas of the insulator and thus causes this portion of the insulator to run hotter or adsorb more heat thereby burning off carbon deposits on this portion of the insulator and thus cause the sensor to be more resistant to grounding due to the formation of soot deposits. In addition, the configuration also increases the length of a ground path from the metal probe to the ground plane/shell. This reduced thickness and gap 38 will cause end 34 of the insulator to adsorb more heat and run hotter than other portions of the insulator regardless whether the system is in a regeneration mode or not. The ability to run hotter and adsorb more heat is due, at least in part, to the spaced relationship of the peripheral wall 42 and the sensing rod 12 to allow for circulation of heated exhaust gas. The ability to run hotter and adsorb more heat is also due to reduced thickness T of the peripheral wall. As a result of this, the required heat input and/or time to cause bum off carbon deposits or other deposits (e.g., capable of building a conductive path from rod 12 to casing 14 and thus forming a ground) is reduced.

In one exemplary embodiment, an exhaust control system is provided for monitoring and removing particulate matter from an exhaust gas stream. The exhaust system includes and exhaust control device, such as a particulate matter filter, which is in fluid communication with an engine through a suitable exhaust gas conduit. The exhaust control system also includes one or more particulate matter sensors. As exhaust gas flows through the exhaust gas conduit, particulate matter for a given time period is determined by monitoring an electrical signal across a surface of the probe generated by an electrical potential of particles flowing past the probe to determine the amount of particulate matter that has flowed into the exhaust control device. The particulate matter sensor generates signals based upon the charged particles flowing past the probe. The signals are received by a controller configured for determining the total amount of particulate matter that has flowed past the probe and into the particulate matter filter based upon the signals received.

Further exemplary embodiments include monitoring particulate matter flowing within an exhaust gas stream using a sensing rod constructed in accordance with exemplary embodiments of the present invention. In one embodiment, the method includes generating signals with the particulate matter sensor based upon the presence of particulate matter flowing in the exhaust gas stream and flowing past the sensor and thus creating an electrical signal in the probe based upon the electrically charged particles or the electrical potential of the particles flowing past the sensing rod of the probe. As previously mentioned and in one exemplary embodiment, the signal is based upon a charge created in the probe based upon particulate matter flowing past the sensor. The controller receives the signals and determines at least one flow characteristic of particulate matter flowing within the exhaust gas stream such as total amount of particulate matter flowing by the sensor and into the emission control device, or volume flow rate of particulate matter or otherwise.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed as the best mode contemplated for carrying out this invention, but that the invention will include all embodiments falling within the scope of the present application.

What is claimed is:

1. A particulate matter sensor for an exhaust system of an engine, comprising:
a casing having an attachment feature for mounting the particulate matter sensor to the exhaust system;
an insulator disposed within the casing, the insulator having a first end located proximate to an electrical connector of the particulate matter sensor and a second end located opposite thereof, the second end extending away from the casing; and
a sensing rod having a first end and a second end, the first end of the sensing rod being supported by the insulator and spaced from an inner surface of the second end of the insulator to form a gap therebetween.

2. The particulate matter sensor of claim 1, wherein the insulator includes a peripheral wall that terminates at the second end of the insulator and defines the gap, the peripheral wall having a thickness that varies along a length of the insulator.

3. The particulate matter sensor of claim 2, wherein the peripheral wall is tapered such that its thickness decreases from a first position remote from the second end of the insulator to a second position at the second end of the insulator.

4. The particulate matter sensor of claim 1, wherein the second end of the insulator includes a peripheral wall that includes an outer periphery that extends along a length of the insulator that defines the gap, the outer periphery including a generally constant diameter.

5. The particulate matter sensor of claim 1, wherein the gap is formed between a peripheral wall of the insulator and the sensing rod, the gap includes a width that varies along an axis of the sensing rod.

6. The particulate matter sensor of claim 5, wherein the width of the gap is greater at the second end of the insulator.

7. The particulate matter sensor of claim 1, wherein the gap extends along a length of the insulator that is at least about one-tenth of a total length of the insulator.

8. The particulate matter sensor of claim 1, wherein the gap extends along a length of the insulator that is at least about one-half of a total length of the insulator.

9. A method of monitoring particulate matter flowing within an exhaust gas stream, comprising:
supporting a sensing rod with an insulator disposed between the sensing rod and a casing, the insulator being shaped to form a gap between an inner surface of an opening of the insulator and an exterior surface of the sensing rod;
positioning the sensing rod within the exhaust gas stream and maintaining the position of the sensing rod through the casing; and
generating electrical signals with the sensing rod based upon particulate matter flowing within the exhaust gas stream.

10. The method of claim 9, wherein the gap between the sensing rod and insulator extends along a length of the insulator.

11. The method of claim 10, wherein the gap includes a width that increases towards an end portion of the insulator.

12. The method of claim 11, wherein the length in which the gap extends is at least about one-quarter of a total length of the insulator.

13. The method of claim 11, wherein the length in which the gap extends is at least about one-tenth of a total length of the insulator.

14. The method of claim 9, wherein the insulator includes a peripheral wall that terminates at a distal end of insulator and defines the gap, the peripheral wall having a thickness that varies along a length of the insulator.

15. The method of claim 14, wherein the length in which the gap extends is at least about one-quarter of a total length of the insulator.

16. The method of claim 14, wherein the length in which the gap extends is at least about one-tenth of a total length of the insulator.
